(19) United States
(12) Patent Application Publication
(10) Pub. No.: US 2018/0025324 A1
(43) Pub. Date: Jan. 25, 2018

(54) INFORMATION PROCESSING APPARATUS, INFORMATION PROCESSING METHOD AND COMPUTER READABLE STORAGE MEDIUM

(71) Applicant: CASIO COMPUTER CO., LTD., Tokyo (JP)

(72) Inventor: Keita Anjo, Tokyo (JP)

(21) Appl. No.: 15/652,943

(22) Filed: Jul. 18, 2017

(30) Foreign Application Priority Data
Jul. 20, 2016 (JP) 2016-142224

(51) Int. Cl. G06Q 10/10; G06F 3/0482

(52) U.S. Cl. CPC G06Q 10/1093; G06F 3/0482; G06F 3/04883

(57) ABSTRACT

An information processing apparatus, including: a first display control section which performs control to display a schedule template provided with a plurality of schedule frames each of which is correlated with predetermined date information or time slot information; a first selection section which selects a schedule frame desired by a user according to user's operation from among the plurality of schedule frames; a choosing section which chooses a stamp mark as a selection candidate; a second display control section which performs control to display the stamp mark as the selection candidate; and a second selection section which selects a predetermined stamp mark according to user's operation from among the stamp mark as the selection candidate, wherein the first display control section performs control to display the stamp mark selected by the second selection section by placing the stamp mark on the schedule frame.

### CROSS-REFERENCE TO RELATED APPLICATION

This application is based upon and claims the benefit of priority from the prior Japanese Patent Application No. 2016-142224, filed on Jul. 20, 2016, the entire contents of which are incorporated herein by reference.

### BACKGROUND OF THE INVENTION

### 1. Field of the Invention

The present invention relates to an information processing apparatus, an information processing method and a computer readable storage medium.

### 2. Description of Related Art

Conventionally, there have been known to-do management apparatuses which manage tasks to be performed by users.

There has been also known an information processing apparatus which is shared by a plurality of users in a family, displays a message which was input by an arbitrary user upon activation and then displays a schedule on a calendar (Japanese Patent Application Laid Open Publication No. H9-120418).

### SUMMARY OF THE INVENTION

There is provided an information processing apparatus, including: a first display control section which performs control to display a schedule template that is provided with a plurality of schedule frames each of which is correlated with predetermined date information or time slot information; a first selection section which selects a schedule frame desired by a user according to user's operation from among the plurality of schedule frames; a choosing section which chooses a stamp mark as a selection candidate from among a plurality of stamp marks that are different from each other; a second display control section which performs control to display the stamp mark as the selection candidate that is chosen by the choosing section; and a second selection section which selects a predetermined stamp mark according to user's operation from among the stamp mark as the selection candidate that is displayed by the second display control section, wherein the first display control section performs control to display the stamp mark which is selected by the second selection section by placing the stamp mark on the schedule frame which is selected by the first selection section in the schedule template.

There is provided an information processing method, including: a first display control step of performing control to display a schedule template that is provided with a plurality of schedule frames each of which is correlated with predetermined date information or time slot information; a first selection step of selecting a schedule frame desired by a user according to user's operation from among the plurality of schedule frames; a choosing step of choosing a stamp mark as a selection candidate from among a plurality of stamp marks that are different from each other; a second display control step of performing control to display the stamp mark as the selection candidate that is chosen by the choosing step; and a second selection step of selecting a predetermined stamp mark according to user's operation from among the stamp mark as the selection candidate that is displayed by the second display control step, wherein the first display control step includes performing control to display the stamp mark which is selected by the second selection step by placing the stamp mark on the schedule frame which is selected by the first selection step in the schedule template.

There is provided a non-transitory computer readable storage medium which stores a program for causing a computer of an information processing apparatus to execute a procedure including: a first display control process of performing control to display a schedule template that is provided with a plurality of schedule frames each of which is correlated with predetermined date information or time slot information; a first selection process of selecting a schedule frame desired by a user according to user's operation from among the plurality of schedule frames; a choosing process of choosing a stamp mark as a selection candidate from among a plurality of stamp marks that are different from each other; a second display control process of performing control to display the stamp mark as the selection candidate that is chosen by the choosing process; and a second selection process of selecting a predetermined stamp mark according to user's operation from among the stamp mark as the selection candidate that is displayed by the second display control process, wherein the first display control process includes performing control to display the stamp mark which is selected by the second selection process by placing the stamp mark on the schedule frame which is selected by the first selection process in the schedule template.

### BRIEF DESCRIPTION OF THE DRAWINGS

The above and other objects, advantages and features of the present invention will become more fully understood from the detailed description given hereinafter and the appended drawings which are given byway of illustration only, and thus are not intended as a definition of the limits of the present invention, and wherein:

FIG. 1 is a block diagram showing a shop data management system in an embodiment of the present invention;

FIG. 2 is a block diagram showing a functional configuration of a server;

FIG. 3 is a block diagram showing a functional configuration of a terminal apparatus;

FIG. 4 is a view showing a configuration of an account data table;

FIG. 5 is a view showing a configuration of a calendar area data table;

FIG. 6 is a view showing a configuration of a mode data table;

FIG. 7 is a view showing a configuration of a stamp data table;

FIG. 8 is a view for showing an example of a position coordinate of a schedule frame;

FIG. 9 is a flowchart showing information display input processing;

FIG. 10 is a flowchart showing stamp attachment display control processing;

FIG. 11 is a flowchart showing a sequel to the stamp attachment display control processing in FIG. 10;

FIGS. 12A and 12B are views showing examples of display screens of the terminal apparatus when the stamp attachment display control processing is executed;

FIG. 13 is a view showing an example of a display screen of the terminal apparatus when the stamp attachment display control processing is executed;

FIGS. 14A and 14B are views showing examples of display screens of the terminal apparatus when the stamp attachment display control processing is executed;

FIG. 15 is a view showing an example of a display screen of the terminal apparatus when the stamp attachment display control processing is executed;

FIGS. 16A and 16B are views showing examples of display screens of the terminal apparatus when the stamp attachment display control processing is executed;

FIG. 17 is a view showing an example of a display screen of the terminal apparatus when the stamp attachment display control processing is executed;

FIGS. 18A and 18B are views showing examples of display screens of the terminal apparatus when the stamp attachment display control processing is executed;

FIGS. 19A and 19B are views showing examples of display screens of the terminal apparatus when the stamp attachment display control processing is executed; and

FIGS. 20A and 20B are views showing examples of schedule templates.

### DETAILED DESCRIPTION OF THE PREFERRED EMBODIMENT

Hereinafter, an embodiment of the present invention will be described in detail with reference to the accompanying drawings. The present invention is not limited to the illustrated examples.

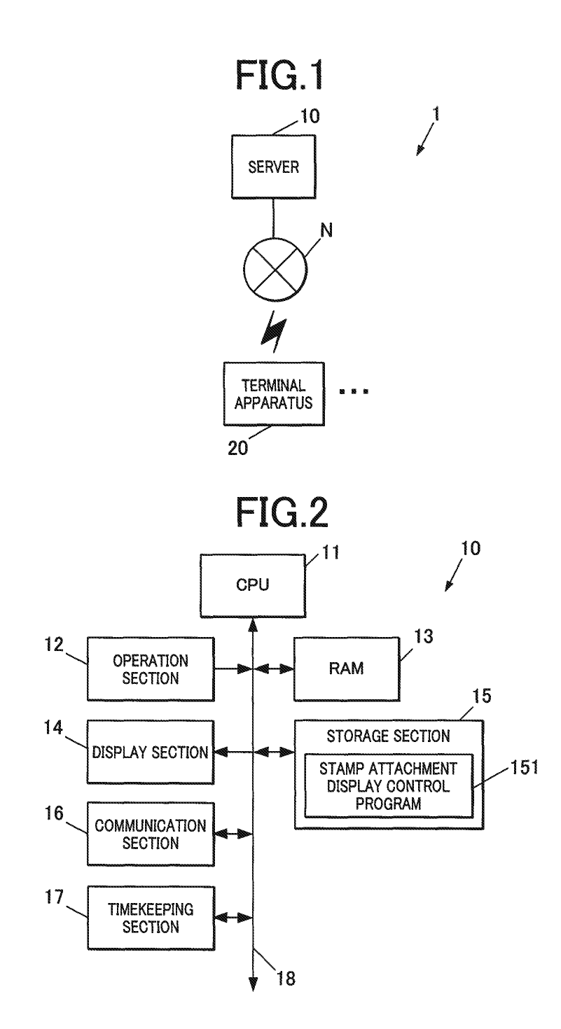

An apparatus configuration of the embodiment will be described with reference to FIGS. 1 to 3. A shop data management system 1 in the embodiment will be described with reference to FIG. 1. FIG. 1 is a block diagram showing the shop data management system 1 in the embodiment.

The shop data management system 1 includes a server 10 and a plurality of terminal apparatuses 20. In the embodiment, the shop data management system 1 is a system shared by a plurality of workers (owner, shop manager, part-timers and such like) working in an independently operated restaurant as an example. However, the present invention is not limited to this example.

The server 10 is a server which is connected to a communication network N and manages shop data regarding tasks that the users of the terminal apparatuses 20 are in charge of. Though the communication network N is an internet here, the communication network N may be other networks such as a LAN (Local Area Network).

The terminal apparatuses 20 are portable terminal apparatuses owned by respective users as workers of the restaurant. Here, the description is made for a case where the terminal apparatuses 20 are smartphones. However, the present invention is not limited to this, and the terminal apparatuses 20 may be other portable terminal apparatuses such as a tablet PC (Personal Computer), a portable phone, a PDA (Personal Digital Assistant) and a notebook PC and terminal apparatuses such as a desktop PC. Each of the terminal apparatuses 20 receives input such as user's operation, transmits the input to the server 10 and displays information received from the server 10. The terminal apparatuses 20 are connected to the communication network N via a base station, an access point or the like (none of them shown in the drawings) on the communication network N.

The shop data management system 1 has a configuration in which the server 10 manages shop data regarding jobs that the respective users of the plurality of terminal apparatuses 20 are in charge of. However, the present invention is not limited to this. The shop data management system 1 may have a configuration including a single terminal apparatus 20 owned by a single personal user or may have a configuration sharing a single terminal apparatus 20 between a plurality of users.

Next, a functional configuration inside the server 10 will be described with reference to FIG. 2. FIG. 2 is a block diagram showing the functional configuration of the server 10.

As shown in FIG. 2, the server 10 includes a CPU (Central Processing Unit) 11 as a first display control section, a second display control section, a third display control section, an extraction section and a choosing section, an operation section 12, a RAM (Random Access Memory) 13, a display section 14, a storage section 15 as a first storage section and a second storage section, a communication section 16 as a first selection section, a second selection section and a third selection section, and a timekeeping section 17. The sections in the server 10 are connected to each other via a bus 18.

The CPU 11 controls the sections in the server 10. The CPU 11 reads a program which was specified from among system programs and application programs stored in the storage section 15, loads the program into the RAM 13 and executes various types of processing in cooperation with the program.

The operation section 12 has an input section such as a keyboard and a pointing device such as a mouse, receives key input and position input and outputs the operation information to the CPU 11.

The RAM 13 is a volatile memory, and forms a working area for temporarily storing various types of data and programs. The display section 14 is configured by including an LCD (Liquid Crystal Display), an EL (Electro Luminescence) display or the like, and performs various types of display in accordance with display information instructed from the CPU 11.

The storage section 15 is a storage section which is configured by including an HDD (Hard Disc Drive), and an SSD (Solid State Drive) or the like, and capable of writing and reading data and programs. Especially, the storage section 15 stores a stamp attachment display control program 151, an after-mentioned account data table 30, a calendar area data table 40, a mode data table 50, a stamp data table 60 and such like.

The communication section 16 is configured by including a network card or the like, communicably connected to the communication network N and communicates with equipment on the communication network N. The CPU 11 can communicate with the terminal apparatuses 20 on the communication network N via the communication section 16.

The timekeeping section 17 is a real time clock which keeps current date and time and outputs the kept current date and time information to the CPU 11.

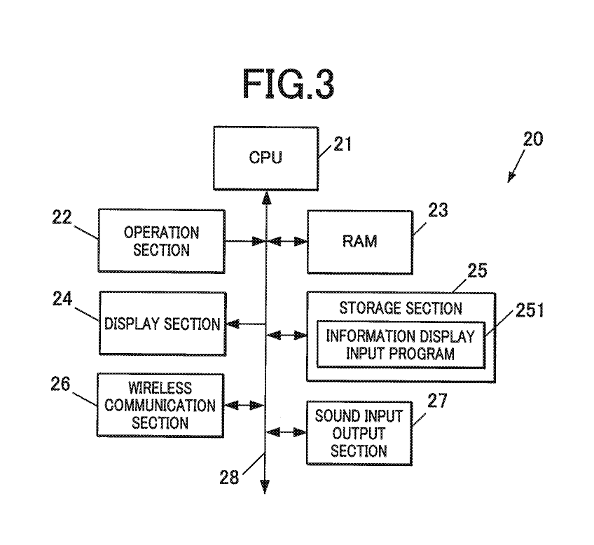

Next, a functional configuration of each of the terminal apparatuses 20 will be described with reference to FIG. 3. FIG. 3 is a block diagram showing the functional configuration of the terminal apparatus 20.

The terminal apparatus 20 includes a CPU 21, an operation section 22, a RAM 23, a display section 24, a storage section 25, a wireless communication section 26 and a sound input output section 27. The sections of the terminal apparatus 20 are connected to each other via a bus 28.

Since the CPU 21, the RAM 23 and the display section 24 are similar to the CPU 11, the RAM 13 and the display section 14 of the server 10, the overlapping description is omitted and description will be described mainly for the differences.

The CPU 21 controls the sections in the terminal apparatus 20. The operation section 22 has a touch panel provided on a display screen of the display section 24, receives touch input from a user and outputs the operation information to the CPU 21.

The storage section 25 is a storage section which is configured by including a flash memory, an EEPROM (Electrically Erasable Programmable ROM) or the like, and capable of writing and reading data and programs. Especially, the storage section 25 stores an information display input program 251.

The wireless communication section 26 is configured by including an antenna, a modulation demodulation circuit, a signal processing circuit and such like, and performs transmission and reception of information by wireless radio waves with the base station, the access point or the like on the communication network N. Thus, the CPU 21 can communicate with the server 10 via the base station, the access point or the like on the communication network N by the wireless communication section 26.

The sound input output section 27 is configured by including a sound input section such as a microphone and an AD converter, and a sound output section such as a DA converter, an amplifier and a speaker. Upon sound input, the sound input output section 27 receives input of user's sound from the microphone, converts the sound input signal into digital sound input information and outputs the converted information to the CPU 21. Upon sound output, the sound input output section 27 converts the sound output signal into an analog sound output signal and outputs the sound from the speaker. The illustration and description of other components such as a positioning section are omitted for the terminal apparatus 20 as a smartphone.

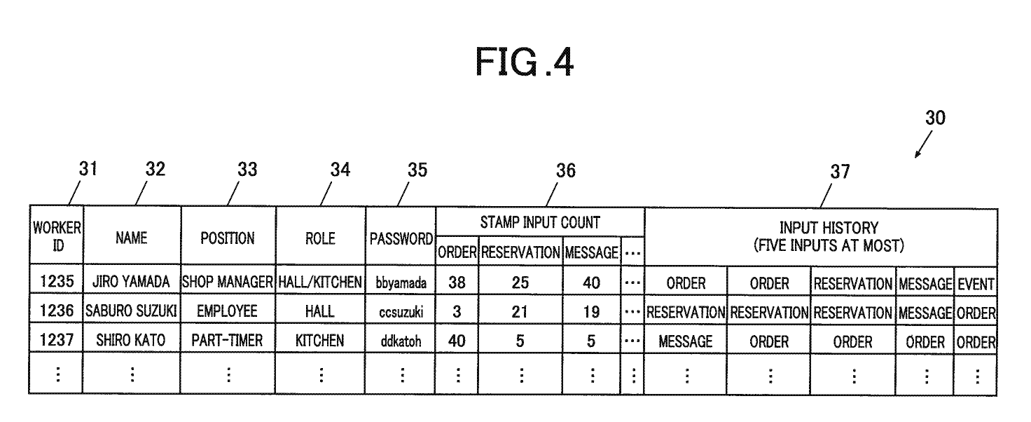

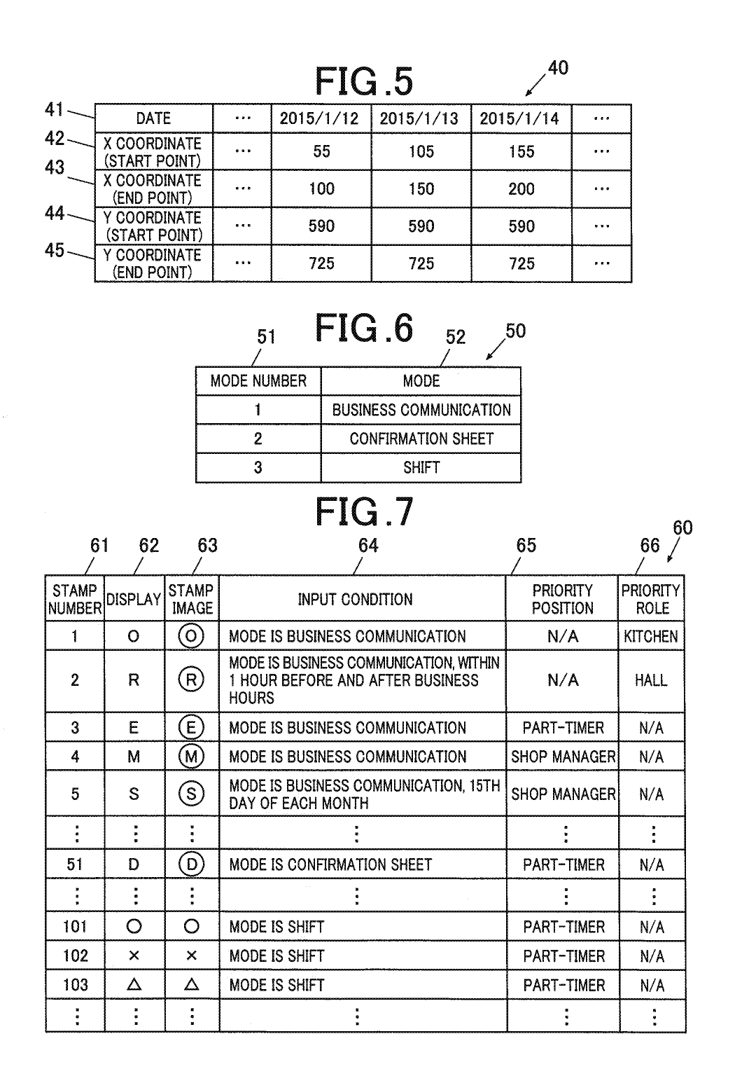

With reference to FIGS. 4 to 7, description will be made for the account data table 30, the calendar area data table 40, the mode data table 50 and the stamp data table 60 stored in the storage section 15 of the server 10. FIG. 4 is a view showing the configuration of the account data table 30. FIG. 5 is a view showing the configuration of the calendar area data table 40. FIG. 6 is a view showing the configuration of the mode data table 50. FIG. 7 is a view showing the configuration of the stamp data table 60.

The account data table 30 is a table having account information of workers (users of the terminal apparatuses 20) in the restaurant. The account data table 30 has items of a worker ID 31, a name 32, a position 33, a role 34, a password 35, a stamp input count 36 and an input history 37.

The worker ID 31 is identification information of a worker in the restaurant, and also functions as a login ID in the embodiment. The name 32 is information on a name of the worker of the worker ID 31. The position 33 is information on a position of the worker of the worker ID 31. The role 34 is information on a role in the job of the worker of the worker ID 31. The password 35 is information of a password of the worker of the worker ID 31. The stamp input count 36 is information on the number of inputs for each stamp by the worker of the worker ID 31. The input history 37 is information on the input history of the worker of the worker ID 31, and records last five stamp inputs as a target in the embodiment.

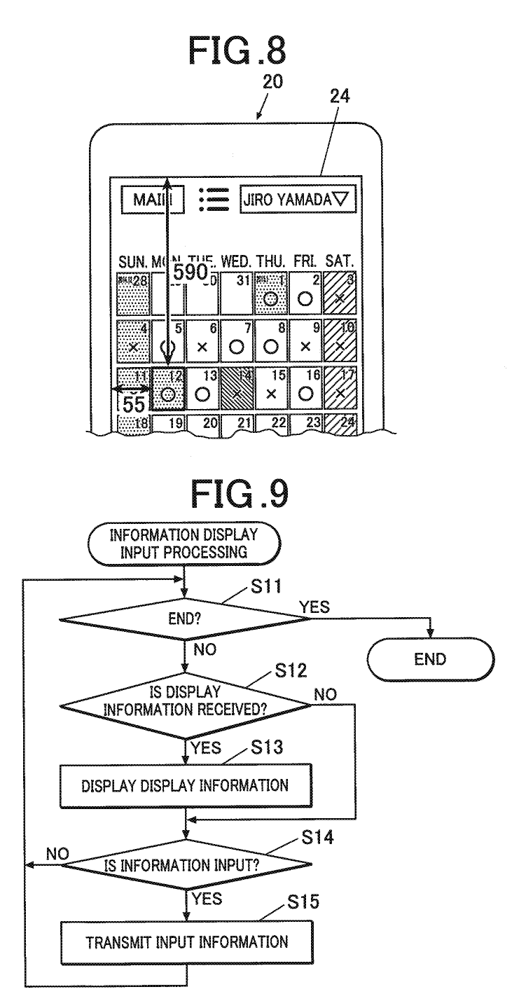

The calendar area data table 40 is a table having display area information (position coordinate information) of each date frame when displaying date frames (schedule frames) of the calendar information on the display section 24 of the terminal apparatus 20. The calendar area data table 40 has items of a date 41, an X coordinate (start point) 42, an X coordinate (end point) 43, a Y coordinate (start point) 44 and a Y coordinate (end point) 45. In the calendar area data table 40 shown in FIG. 5, calendar area data corresponding to the screen size of the terminal apparatus 20 shown in FIG. 8 is illustrated. Though not shown in the drawings, the calendar area data table 40 also has other calendar area data corresponding to a plurality of screen sizes.

The date 41 is information on a date displayed as calendar information. The X coordinate (start point) 42 is information on the X coordinate (start point) of the date frame of the date 41. For example, the X coordinate (start point) of the date frame of Jan. 12, 2015 is the position of 55 pixels and displayed at the position of 55 pixels from the left end of the display section 24 as shown in FIG. 8. The X coordinate (end point) 43 is information on the X coordinate (end point) of the date frame of the date 41. The Y coordinate (start point) 44 is information on the Y coordinate (start point) of the date frame of the date 41. For example, the Y coordinate (start point) of the date frame of Jan. 12, 2015 is the position of 590 pixels, and displayed at the position of 590 pixels from the upper end of the display section 24 as shown in FIG. 8. The Y coordinate (end point) 45 is information on the Y coordinate (end point) of the date frame of the date 41.

The mode data table 50 is a data table defining types of modes which can be executed in the shop data management system 1. The mode data table 50 has items of a mode number 51 and a mode 52. The mode number 51 is identification information of the mode. The mode 52 is information on a name of the mode.

The stamp data table 60 is a data table defining stamps as stamp marks displayed on the calendar. The stamp data table 60 has items of a stamp number 61, a display 62, a stamp image 63, an input condition 64, a priority position 65 and a priority role 66.

The stamp number 61 is identification information on a stamp which is set for each type of items to be input and displayed on the calendar. The display 62 is information on a character part of the stamp of the stamp number 61. The stamp image 63 is display image data of the stamp of the stamp number 61. The input condition 64 is information on the input condition (attachment condition) of the stamp of the stamp number 61. The priority position 65 and the priority role 66 are information which is used as a determination element of a stamp to be chosen with priority when choosing stamps which are selection candidates when a user (worker) selects the stamp.

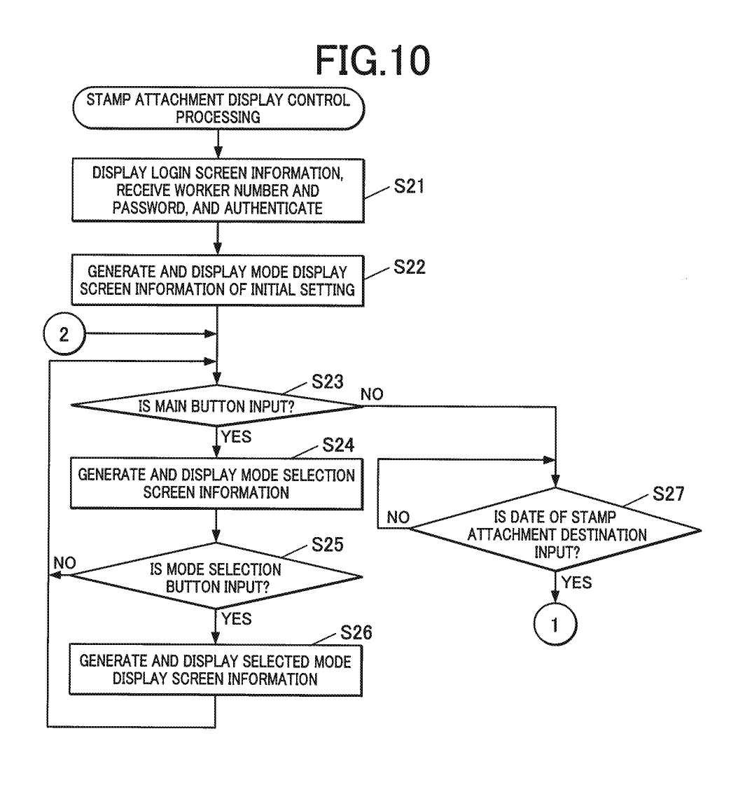

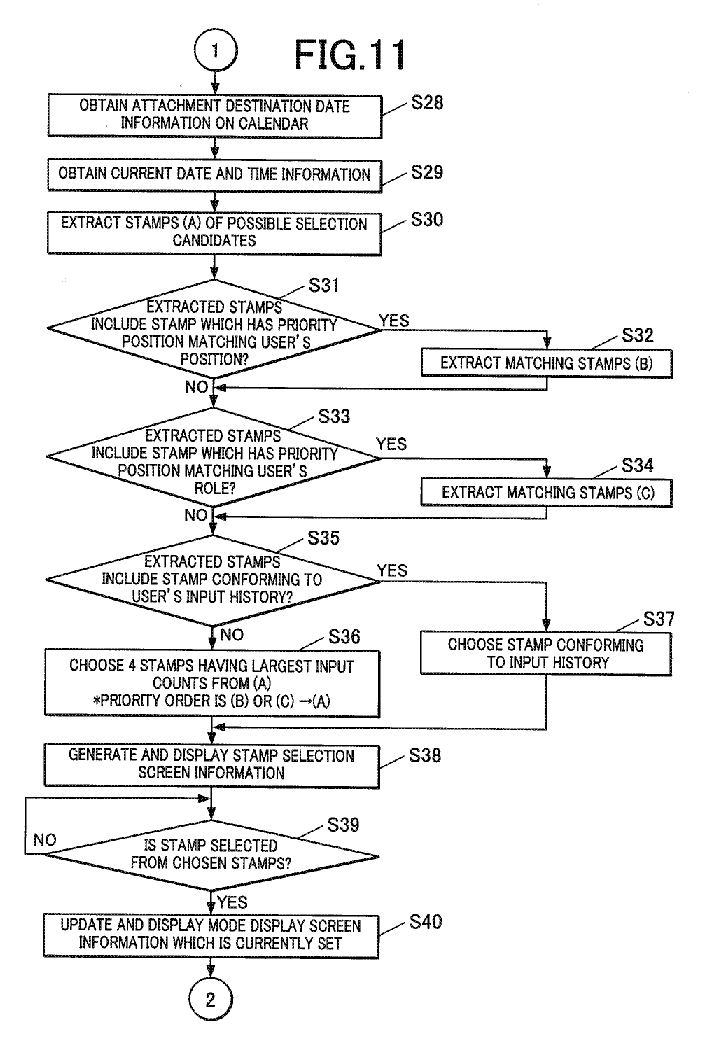

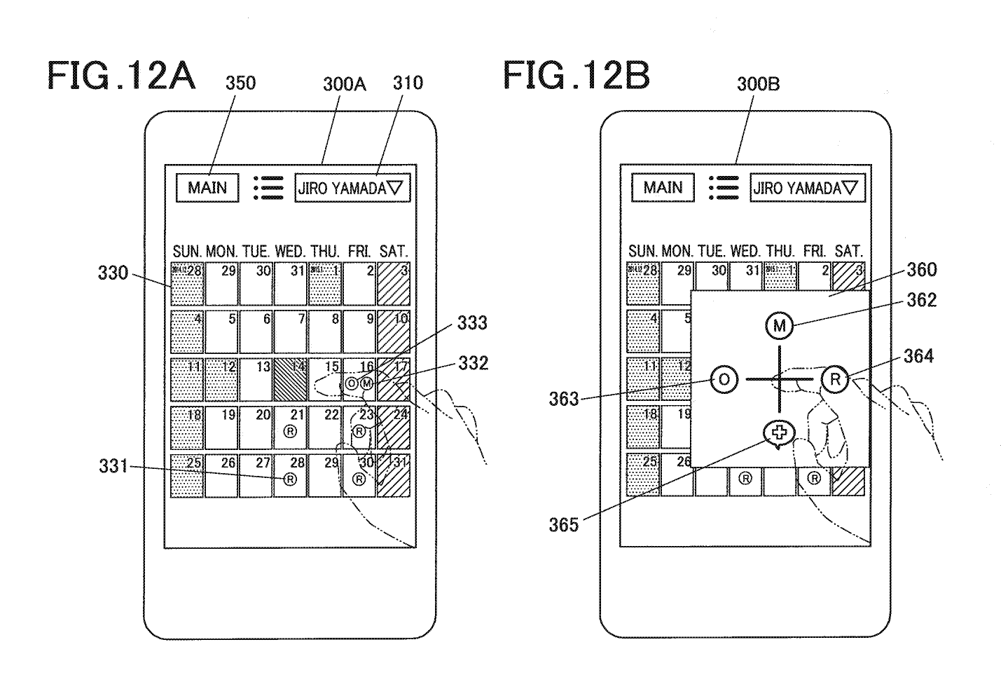

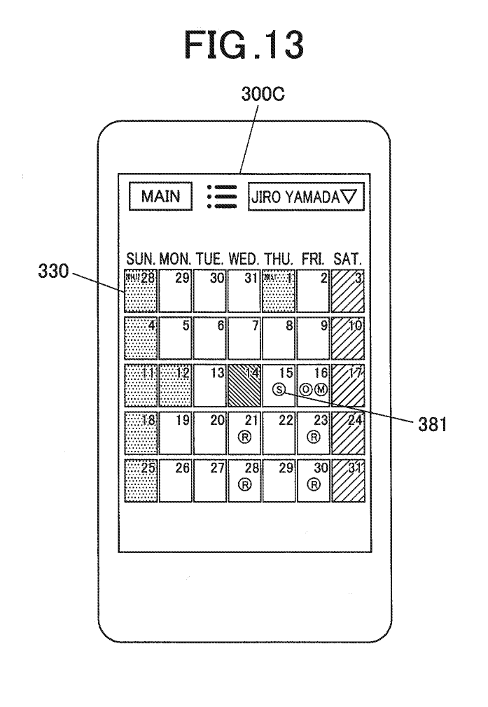

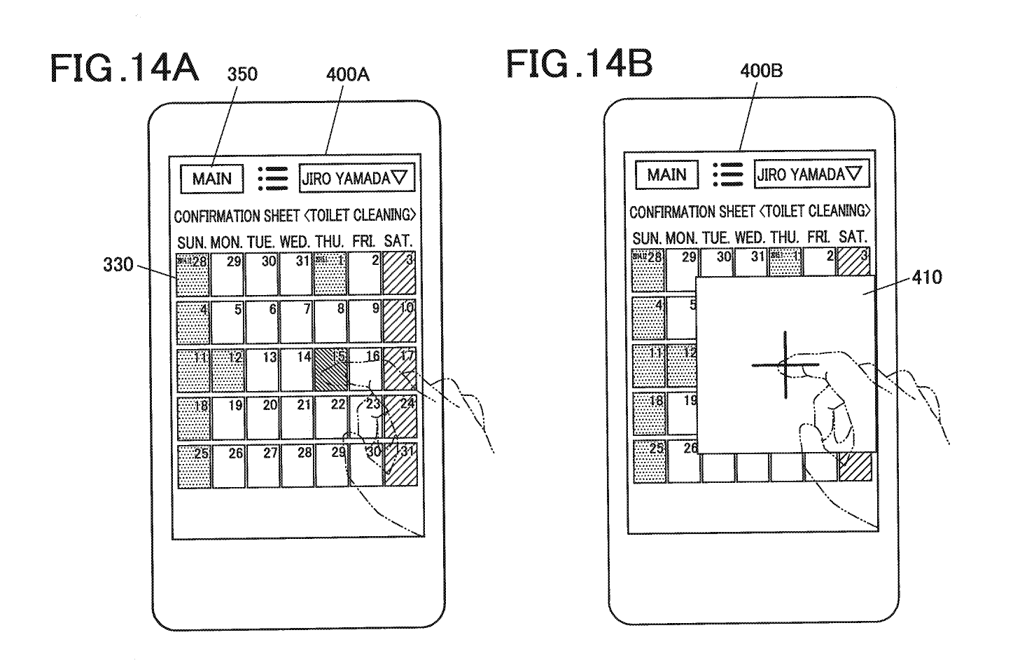

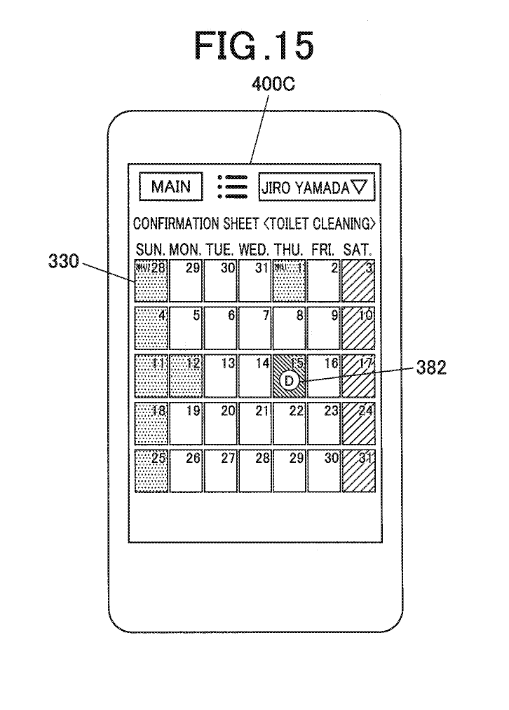

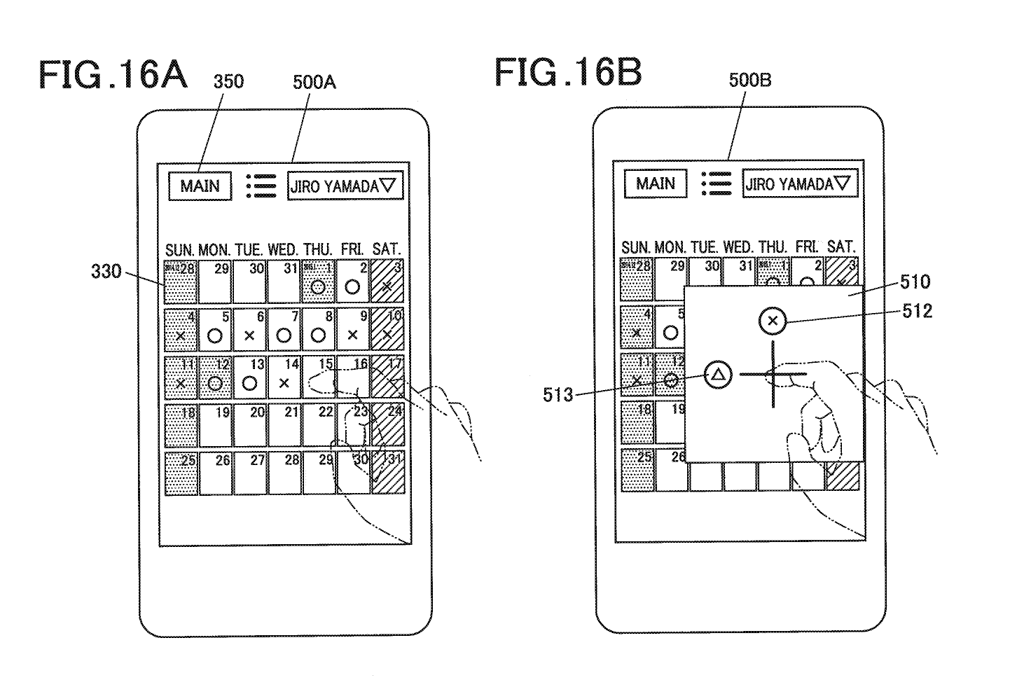

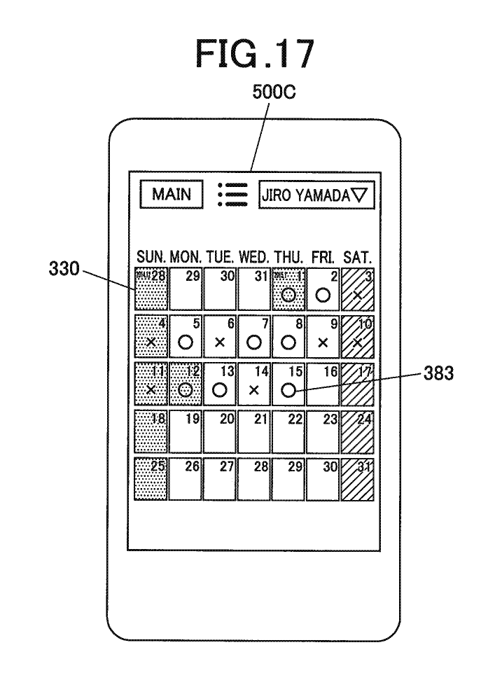

The operation of the shop data management system 1 will be described with reference to FIGS. 9 to 17. FIG. 9 is a flowchart showing information display input processing. FIG. 10 is a flowchart showing stamp attachment display control processing. FIG. 11 is a flowchart showing a sequel to the stamp attachment display control processing of FIG. 10. FIGS. 12A, 12B and 13 are views showing display screens under respective situations when the stamp attachment display control processing is executed in a business communication mode. FIGS. 14A, 14B and 15 are views showing display screens under respective situations when the stamp attachment display control processing is executed in a confirmation sheet mode. FIGS. 16A, 16B and 17 are views showing display screens under respective situations when the stamp attachment display control processing is executed in a shift mode.

Information display input processing executed in the terminal apparatus 20 will be described with reference to FIG. 9. The information display input processing is processing of displaying the display information regarding the stamp attachment display control processing and receiving input of information. In the terminal apparatus 20, triggered by input of an execution instruction of the information display input processing from a user via the operation section 22, the CPU 21 executes the information display input processing in cooperation with the information display input program 251 which was read from the storage section 25 and appropriately loaded onto the RAM 23.

First, the CPU 21 determines whether the end instruction of the information display input processing was input via the operation section 22 (step S11).

In step S11, if it is determined that the end instruction was input (step S11; YES), the CPU 21 ends the information display input processing.

On the other hand, in step S11, if it is not determined that the end instruction was input (step S11; NO), the CPU 21 determines whether display information was received from the server 10 via the wireless communication section 26 (step S12).

In step S12, if it is determined that the display information was received (step S12; YES), the CPU 21 displays the received display information on the display section 24 (step S13). The CPU 21 then determines whether or not information was input by operation input other than the end instruction via the operation section 22 or sound input via the sound input output section 27 (step S14).

On the other hand, in step S12, if it is not determined that the display information was received (step S12; NO), the CPU 21 skips step S13 and proceeds to step S14.

In step S14, if it is determined that information was input (step S14; YES), the CPU 21 transmits the input information (operation information, text information, sound information and such like) which was input in step S14 to the server 10 via the wireless communication section 26 (step S15) and proceeds to step S11.

On the other hand, in step S14, if it is not determined that information was input (step S14; NO), the CPU 21 proceeds to step S11.

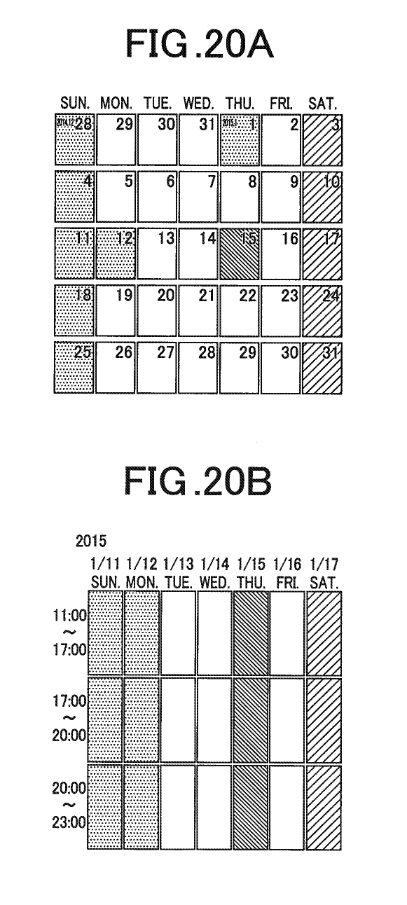

The stamp attachment display control processing executed in the server 10 will be described with reference to FIGS. 10 to 17. The stamp attachment display control processing is processing of making a user (worker in the restaurant) select a desired stamp from among the chosen stamp candidates and attaching and displaying the selected stamp on the calendar information. The calendar information is a schedule template provided with a plurality of schedule frames each of which is correlated with predetermined date information or time slot information. In the embodiment, as shown in FIG. 20A, the schedule frames are set to be dates, and a list of the plurality of dates is displayed in a chronological arrangement.

In the terminal apparatus 20 of a user, corresponding to step S14 of information display input processing of FIG. 9, the execution instruction of stamp attachment display control processing is input, and the execution instruction of stamp attachment display control processing is transmitted to the server 10 in step S15. In this case, in the server 10, corresponding to step S15 of FIG. 9, triggered by reception of the execution instruction of the stamp attachment display control processing from the terminal apparatus 20 via the communication section 16, the CPU 11 executes the stamp attachment display control processing in cooperation with the stamp attachment display control program 151 which was read from the storage section 15 and appropriately loaded onto the RAM 13.

First, the CPU 11 generates login screen information. Corresponding to steps S12 and S15 of the information display input processing of FIG. 9, the CPU 11 transmits the generated login screen information to the terminal apparatus 20 which is the communication destination via the communication section 16 to display the login screen, receives the worker ID as the login ID and the password from the terminal apparatus 20 of the communication destination, reads the account data table 30 from the storage section 15 and performs login authentication by using the received worker ID and password and the account data table 30 (step S21). The login screen information has an input region of the login ID and the password.

That is, corresponding to this step S21, the CPU 21 of the terminal apparatus 20 receives the login screen information to display the login screen in steps S12 and S13 of FIG. 9, and performs input of the worker ID as the login ID and the password via the operation section 22 and transmission of the input information to the server 10 in steps S14 and S15 of FIG. 9.

The CPU 11 performs login authentication according to whether the received worker ID and the password are contained in the records of the worker IDs 31 and the passwords 35 in the account data table 30.

The CPU 11 obtains current date and time information from the timekeeping section 17, reads the calendar area data table 40, the stamp data table 60 and such like from the storage section 15, generates mode display screen information (for example, business communication screen information) of an initial setting corresponding to the user authenticated in step S21 by using the current date and time information, the account data table 30, the calendar area data table 40, the stamp data table 60 and such like. Corresponding to step S12 of FIG. 9, the CPU 11 transmits the generated mode display screen information to the terminal apparatus 20 of the communication destination via the communication section 16 to display the mode display screen (step S22).

In step S22, the CPU 11 prepares calendar information of the present month corresponding to the current date and time information and places the stamp image 63 of the stamp which needs to be displayed on the corresponding date of the calendar information. The CPU 11 generates business communication screen information including a display region of the calendar information on which the stamp was placed, a display region of the name 32 of the worker who performed the login and a main button. In the embodiment, by the login user performing touch operation of a schedule frame on the calendar information, a plurality of stamp buttons which is supposed to be input to the schedule frame by the login user is displayed, and a stamp number of a stamp button can be specified by input of the stamp button.

That is, corresponding to this step S22, the CPU 21 of the terminal apparatus 20 performs reception and display of the business communication screen information in steps S12 and S13 of FIG. 9. In step S22, business communication screen information indicating a business communication screen 300A shown in FIG. 12A is generated.

The business communication screen 300A has a login user display region 310, a calendar display region 330 and a main button 350. The login user display region 310 is a display region of the login user. Here, the business communication screen 300A is an example in which the login user of the login user display region 310 is Jiro Yamada who is a shop manager.

The calendar display region 330 is a display region of calendar information in which a stamp is placed on the calendar information of the present month when the login is performed. The calendar display region 330 includes, for example, a stamp 331 for a task of reservation, a stamp 332 for a task of message and a stamp 333 for a task of order. The stamps of the calendar display region 330 can be input by user's touch input.

The main button 350 is a button for receiving selection input of any one mode among the business communication mode, a confirmation sheet mode and a shift mode. Here, the business communication mode is a mode in which a worker of the restaurant performs business communication by registering a task of a job for the worker or for another worker with a stamp and displaying the task of the registered stamp on the calendar information. In the embodiment, when the login authentication is performed in step S21, the mode is first set to the business communication mode. The confirmation sheet mode is a mode in which a predetermined stamp (for example, the stamp marked D (which means “done”)) is registered in the schedule frame (date frame) of a sheet (calendar information) which is set for each of the tasks to be periodically performed, the registered stamp is displayed on the calendar information, and thereby the completion of the task is notified for the date having the predetermined stamp displayed. The shift mode is a mode in which a worker of the restaurant registers a desired shift and confirms a confirmed shift by registering the desired shift with a stamp and displaying the registered stamp on the calendar information.

Corresponding to step S22, the CPU 21 of the terminal apparatus 20 receives input of the schedule frame of the calendar display region 330 or the main button 350 via the operation section 22 and transmits the input information to the server 10 in steps S14 and S15 of FIG. 9.

Corresponding to step S15 of FIG. 9, the CPU 11 determines whether the main button 350 was input according to whether the touch input information of the main button 350 was received from the terminal apparatus 20 of the communication destination via the communication section 16 (step S23).

In step S23, if it is determined that the main button 350 was input (step S23; YES), the CPU 11 generates mode selection screen information for selecting a mode. Corresponding to step S12 of FIG. 9, the CPU 11 transmits the generated mode selection screen information to the terminal apparatus 20 of the communication destination via the communication section 16 to display the mode selection screen information (step S24), and proceeds to step S25.

That is, corresponding to this step S24, the CPU 21 of the terminal apparatus 20 receives and displays the mode selection screen information in steps S12 and S13 of FIG. 9. In addition, corresponding to step S24, the CPU 21 of the terminal apparatus 20 receives input of a mode selection button (not shown in the drawings) for selecting any one mode among the business communication mode, the confirmation sheet mode and the shift mode via the operation section 22 and transmits the input information to the server 10 in steps S14 and S15 of FIG. 9.

Corresponding to step S15 of FIG. 9, via the communication section 16, the CPU 11 determines whether the mode selection button was input according to whether the touch input information of the mode selection button (not shown in the drawings) for selecting any one mode among the business communication mode, confirmation sheet mode and shift mode was received from the terminal apparatus 20 of the communication destination (step S25).

In step S25, if it is not determined that the mode selection button was input (step S25; NO), the CPU 11 proceeds to step S23.

On the other hand, in step S25, if it is determined that the mode selection button was input (step S25; YES), the CPU 11 generates mode display screen information according to the selected mode, corresponding to step S12 of FIG. 9, transmits the generated mode display screen information to the terminal apparatus 20 of the communication destination to display the mode display screen information via the communication section 16 (step S26), and proceeds to step S23.

Corresponding to this step S26, the CPU 21 of the terminal apparatus 20 receives and displays the mode display screen information in steps S12 and S13 of FIG. 9. In step S26, for example, in a case where the confirmation sheet mode was selected, mode display screen information indicating a confirmation sheet screen 400A shown in FIG. 14A is generated. In a case where the shift mode was selected, mode display screen information indicating a shift screen 500A shown in FIG. 16A is generated. As shown in FIGS. 14A and 16A, the confirmation sheet screen 400A and the shift screen 500A also have a main button 350 and receive input of the main button 350 as needed, which enables the mode switching.

If it is not determined that the main button 350 was input in step S23 (step S23; NO), corresponding to step S15 of FIG. 9, the CPU 11 determines whether the date which is the stamp attachment destination was input according to whether the touch input information of the schedule frame of the calendar display region 330 (see FIGS. 12A, 14A and 16A) was received from the terminal apparatus 20 of the communication destination via the communication section 16 (step S27).

In step S27, if it is not determined that the date of the stamp attachment destination was input (step S27; NO), the CPU 11 performs the determination processing of step S27 until the CPU 11 determines that the date of the stamp attachment destination was input.

In step S27, if it is determined that the date of the stamp attachment destination was input (step S27; YES), the CPU 11 refers to the calendar area data table 40 and obtains date information of the stamp attachment destination on the calendar information (step S28). For example, as shown in FIGS. 12A, 14A and 16A, in a case where touch input was performed for the schedule frame of Thursday, Jan. 15, 2015 of the calendar display region 330, the CPU 11 obtains date information indicating Thursday, Jan. 15, 2015 as the date information of stamp attachment destination on the calendar information.

The CPU 11 then obtains the current date and time information from the timekeeping section 17 (step S29). Here, the CPU 11 obtains date and time information when the date of stamp attachment destination was input.

The CPU 11 extracts stamps which can be selection candidates of the stamp to be attached to the input date (schedule frame) (step S30). Specifically, the CPU 11 extracts the stamps conforming to the input condition 64 of the stamp data table 60 on the basis of the date information of the stamp attachment destination obtained in step S28 and date and time information obtained in step S29. For example, in the business communication mode, stamps corresponding to input conditions 64 indicating that the mode is the business communication mode are extracted. In a case where the mode is the business communication mode and the date indicated by the date information of the stamp attachment destination obtained in step S31 is 15th day of the month, the stamp of the task of stocktaking having the stamp number 61 of “5” is further extracted. On the other hand, even in the business communication mode, in a case where the time indicated by the date and time information obtained in step S35 is out of the business hours, the stamp of the task of reservation having the stamp number 61 of “2” is not extracted.

The CPU 11 determines whether there is a stamp which has the position of priority position 65 matching the position of the login user among the stamps extracted in step S30 (step S31). For example, in a case where the login user is a shop manager (Jiro Yamada), when the mode is the business communication mode, the position (shop manager) of priority position 65 matches the position (shop manager) of login user for the stamp of the task of message having the stamp number 61 of “4” and the stamp of the task of stocktaking having the stamp number 61 of “5”.

In step S31, if it is determined that there is a matching stamp (step S31; YES), the CPU 11 extracts the stamps (step S32) and proceeds to step S33.

On the other hand, in step S31, if it is not determined that there is a matching stamp (step S31; NO), the CPU 11 skips step S32 and proceeds to step S33.

The CPU 11 determines whether there is a stamp which has a role of priority role 66 matching the role of the login user among the stamps extracted in step S30 (step S33). For example, in a case where the login user is Shiro Kato (see FIG. 4), when the mode is the business communication mode, the role (kitchen) of the priority role 66 for the stamp of the task of order having the stamp number 61 of “1” matches the role (kitchen) of the login user.

In step S33, if it is determined that there is a matching stamp (step S33; YES), the CPU 11 extracts the stamp (step S34) and proceeds to step S35.

On the other hand, in step S33, if it is not determined that there is a matching stamp (step S33; NO), the CPU 11 skips step S34 and proceeds to step S35.

The CPU 11 determines whether there is a stamp matching the stamp recorded in the input history 37 of the login user among the stamps extracted in step S30 (step S35).

In step S35, if it is not determined that there is a matching stamp (step S35; NO), the CPU 11 refers to the stamp input count 36 of the login user, and chooses the four stamps having the largest numbers of stamp inputs from among the stamps extracted in step S30 (step S36). In a case where the stamp is extracted in at least one of step S32 and step S34, the CPU 11 chooses the stamp with priority. For example, in a case where the login user is the shop manager (Jiro Yamada) and the date indicated by the date information of the stamp attachment destination obtained in step S28 is 15th day of the present month, when the mode is the business communication mode, the stamp of the task of message having the stamp number 61 of “4” and the stamp of the task of stocktaking corresponding to the stamp number 61 of “5” are chosen with priority in step S32.

On the other hand, in step S35, if it is determined that there is a matching stamp (step S35; YES), the CPU 11 chooses the matching stamp (step S37). Here, the stamp is chosen in the reverse chronological order of the date and time registered in the item of the input history 37.

The CPU 11 generates stamp selection screen information setting the stamp buttons corresponding to the stamps which were chosen in step S36 or S37 as the selection candidates, and corresponding to step S12 of FIG. 9, transmits the generated stamp selection screen information to the terminal apparatus 20 of the communication destination via the communication section 16 to display the stamp selection screen information (step S38).

That is, corresponding to step S38, the CPU 21 of the terminal apparatus 20 receives the stamp selection screen information in steps S12 and S13 of FIG. 9 to display the stamp selection screen information. For example, as shown in FIG. 12A, in the business communication mode, in a case where the login user (Jiro Yamada) performs touch operation of the schedule frame of Thursday, Jan. 15, 2015 in the calendar display region 330, in step S38, there is generated stamp selection screen information for displaying a stamp selection screen 360 which is included in the business communication screen 300B of FIG. 12B.

As shown in FIG. 12B, the stamp selection screen 360 has a stamp button 362 (for example, stamp button of message) corresponding to the stamp which is second in the choosing order at the position of upper side of the screen, a stamp button 363 (for example, stamp button of order) corresponding to the stamp which is third in the choosing order at the position of the left side of the screen, a stamp button 364 (for example, stamp button of reservation) corresponding to the stamp which is fourth in the choosing order at the position of right side of the screen, and a display button 365 at the position of lower side of the screen. The display button 365 is a button for receiving touch input for displaying stamp buttons other than the stamp buttons corresponding to the stamps which are first to fourth in the choosing order. For example, list information of other stamp buttons is displayed by touch input of the display button 365. The timing when the stamp selection screen 360 shown in FIG. 12B was displayed is different from the timing when the information of stamp input count 36 and input history 37 in the account data table 30 shown in FIG. 4 is recorded.

Though not displayed on the stamp selection screen 360, there is set a stamp button (for example, stamp button of stocktaking) corresponding to the stamp which is first in the choosing order at the position in the center of the screen, that is, the position of the schedule frame (see FIG. 12A) to which the login user performed the touch operation. That is, the stamp button corresponding to the stamp which is first in the choosing order is already selected at the time when the login user performs the touch operation to the schedule frame as shown in FIG. 12A and the stamp selection screen 360 is displayed as shown in FIG. 12B. Thus, when the login user releases the touch operation without performing flick operation, the stamp button corresponding to the stamp which is first in the choosing order is input (registered). That is, the stamp which is first in the choosing order can be attached to the schedule frame only by the login user performing one-touch operation to the desired schedule frame. Also for the stamp buttons 362, 363 and 364 corresponding to the stamps which are second to fourth in the choosing order, the stamps corresponding to the stamp buttons 362, 363 and 364 can be attached to the schedule frame only by the login user performing touch operation to the desired schedule frame and thereafter performing flick operation.

As shown in FIG. 14A, when the login user (Jiro Yamada) performs touch operation to the schedule frame of Thursday, Jan. 15, 2015 in the calendar display region 330 in the confirmation sheet mode, in step S38, for example, there is generated stamp selection screen information for displaying a stamp selection screen 410 included in the mode display screen 400B in FIG. 14B.

As shown in FIG. 14B, the stamp buttons corresponding to the stamps which are second to fourth in the choosing order and the display button are not set on the stamp selection screen 410. This is because, in the confirmation sheet mode of the embodiment, the stamp to be used is only the stamp of D mark (“done” mark) (see FIG. 7). Though not displayed on the stamp selection screen 410, the stamp button corresponding to the stamp of D mark is set at the position in the center of the screen, that is, the position (see FIG. 14A) of the schedule frame to which the login user performed the touch operation. That is, the stamp button corresponding to the stamp of D mark is already selected at the time when the login user performs the touch operation to the schedule frame as shown in FIG. 14A and the stamp selection screen 410 is displayed as shown in FIG. 14B. Thus, when the touch operation is released without any other operation, the stamp button corresponding to the stamp of D mark is input (registered). That is, the stamp of D mark can be attached to the schedule frame only by the login user performing one-touch operation to the desired schedule frame.

As shown in FIG. 16A, when the login user (Jiro Yamada) performs touch operation to the schedule frame of Thursday, Jan. 15, 2015 in the calendar display region 330 in the shift mode, in step S38, for example, there is generated stamp selection screen information for displaying a stamp selection screen 510 included in the mode display screen 500B in FIG. 16B.

As shown in FIG. 16B, the stamp selection screen 510 has a stamp button 512 (for example, stamp button of x mark) corresponding to the stamp which is second in the choosing order at the position in the upper side of the screen and a stamp button 513 (for example, stamp button of Δ mark) corresponding to the stamp which is third in the choosing order at the position in the left side of the screen.

Though not displayed on the stamp selection screen 510, there is set a stamp button (for example, stamp button of ∘ mark) corresponding to the stamp which is first in the choosing order at the position in the center of screen, that is, the position (see FIG. 16A) of the schedule frame to which the login user performed the touch operation.

Corresponding to step S38, the CPU 21 of the terminal apparatus 20 receives input of any stamp button via the operation section 22 and transmits the input information to the server 10 in steps S14 and S15 of FIG. 9.

Corresponding to step S15 of FIG. 9, the CPU 11 determines whether any stamp button was input according to whether touch input information of any stamp button was received from the terminal apparatus of the communication destination via the communication section 16 (step S39).

In step S39, if it is not determined that any stamp button was input (step S39; NO), the CPU 11 performs determination processing of step S39 until the CPU 11 determines that any stamp button was input.

In step S39, if it is determined that any stamp button was input (step S39; YES), in accordance with the input of stamp button in step S39, the CPU 11 updates the items of stamp input count 36, input history 37 and such like of the account data table 30, updates the mode display screen information which is currently set, corresponding to step S12 of FIG. 9, transmits the updated mode display screen information to the terminal apparatus 20 of the communication destination to display the mode display screen information via the communication section 16 (step S40) and proceeds to step S23.

That is, corresponding to this step S40, the CPU 21 of the terminal apparatus 20 receives the updated mode display screen information and performs display in steps S12 and S13 of FIG. 9. For example, as shown in FIGS. 12A and 12B, when the login user performs touch operation to the schedule frame of Thursday, Jan. 15, 2015, the stamp selection screen 360 is displayed and thereafter the login user releases the touch operation without performing flick operation, the stamp which is first in the choosing order (for example, stamp of stocktaking task) is input. As shown in FIG. 13, on the updated business communication screen 300C, the stamp 381 of the task of stocktaking is attached to the schedule frame of Thursday, Jan. 15, 2015 in the calendar display region 330.

For example, as shown in FIGS. 14A and 14B, in the confirmation sheet mode, when the login user performs touch operation to the schedule frame of Thursday, Jan. 15, 2015, the stamp selection screen 410 is displayed and thereafter the login user releases the touch operation without performing flick operation, the stamp of D mark is input. As shown in FIG. 15, on the updated display screen 400C, the stamp 382 of D mark is attached to the schedule frame of Thursday, Jan. 15, 2015 of the calendar display region 330.

For example, as shown in FIGS. 16A and 16B, in the shift mode, when the login user performs touch operation to the schedule frame of Thursday, Jan. 15, 2015, the stamp selection screen 510 is displayed and thereafter the login user releases the touch operation without performing flick operation, the stamp which is first in the choosing order (for example, stamp of ∘ mark) is input. As shown in FIG. 17, on the updated display screen 500C, the stamp 383 of ∘ mark is attached to the schedule frame of Thursday, Jan. 15, 2015 of the calendar display region 330.

As described above, according to the embodiment, the server 10 causes the terminal apparatus 20 to display a schedule template (calendar information) provided with a plurality of schedule frames (date frames), selects a schedule frame desired by a user from among the plurality of schedule frames according to user's operation, chooses stamp marks which are selection candidates from the plurality of stamp marks which indicate different types of tasks and are correlated with different message information, causes the terminal apparatus 20 to display the stamp marks of the selection candidates which were chosen, selects a predetermined stamp mark according to user's operation from among the stamp marks which are selection candidates, and causes the terminal apparatus 20 to display the schedule template in which the selected stamp mark is placed on the selected schedule frame.

Thus, data to be input and managed on the calendar can be easily input and grasped. More specifically, by inputting stamps, the data to be input and managed can be input quickly in a short time and the necessity of inputting characters is excessively suppressed. Thus, the data to be input and managed can be easily input even by the portable terminal apparatus 20 such as a smartphone. When a stamp is input, the stamp is selected from among stamps which were chosen as selection candidates in advance. Thus, the data to be input and managed can be input more quickly in a shorter time. Thus, it is possible to reduce the limitation of time by quick input and limitation of location by input with the portable terminal apparatus 20. Various stamps can be displayed in schedule frames on the calendar, and all the data which was input and managed by stamps can be clearly displayed together for each date on the terminal apparatus 20.

On the basis of the situation when the schedule frame was selected, the server 10 extracts stamps which can be selection candidates from among a plurality of stamps and chooses stamps which are selection candidates from among the extracted stamps. Thus, since the stamps supposed to be selected by a user are extracted according to the situation when the schedule frame was selected and the stamps which are selection candidates can be chosen from the extracted stamps, stamp input can be efficiently performed.

In the embodiment, a stamp mark usable timing is set in advance for each of a plurality of stamps, and the server 10 extracts stamps which have stamp mark usable timings matching the timing when the schedule frame was selected. Thus, it is possible to accurately extract stamps which are supposed to be selected by the user.

When the server 10 chooses stamps which are selection candidates, the server 10 chooses four stamps which have largest input counts on the basis of the past input count information for each of the stamps. Thus, it is possible to accurately choose stamps which are selection candidates supposed to be selected by the user.

In the embodiment, a plurality of stamps includes specific stamps for each of which attribute information indicating a specific attribute (position and role) of user is set in advance. When the server 10 chooses the stamps which are selection candidates, the server 10 chooses a specific stamp with priority if the specific stamp is included in the stamps which were extracted from the plurality of stamps in advance as stamps of possible selection candidates and the attribute information set for the specific stamp matches the attribute information of the login user. Thus, it is possible to accurately choose stamps of selection candidates supposed to be selected by the user.

When the server 10 chooses stamps which are selection candidates, if a stamp which was input in the last five inputs is included in the stamps which were extracted in advance from the plurality of stamps as stamps of possible selection candidates, the server 10 chooses the stamp. Thus, it is possible to accurately choose stamps of selection candidates supposed to be selected by the user.

Though the above description discloses an example in which an HDD and an SSD of the storage section 15 are used as a computer readable storage medium of programs according to the present invention, the present invention is not limited to this example. As another computer readable storage medium, a portable storage medium such as a flash memory and a CD-ROM can be applied. As a medium providing program data according to the present invention via a communication line, carrier wave can also be applied to the present invention.

The above description of the embodiment is an example of an information processing apparatus and a program according to the present invention, and thus, the present invention is not limited to this example.

For example, in the embodiment, the stamp usable timing is set in advance for each of a plurality of stamps, and the server 10 extracts a stamp which has a stamp usable timing (date and time information) matching the timing (date and time information) when the schedule frame was selected. However, the present invention is not limited to this. For example, the server 10 may extract a stamp which has a stamp usable timing matching the timing indicated by the date information of the selected schedule frame.

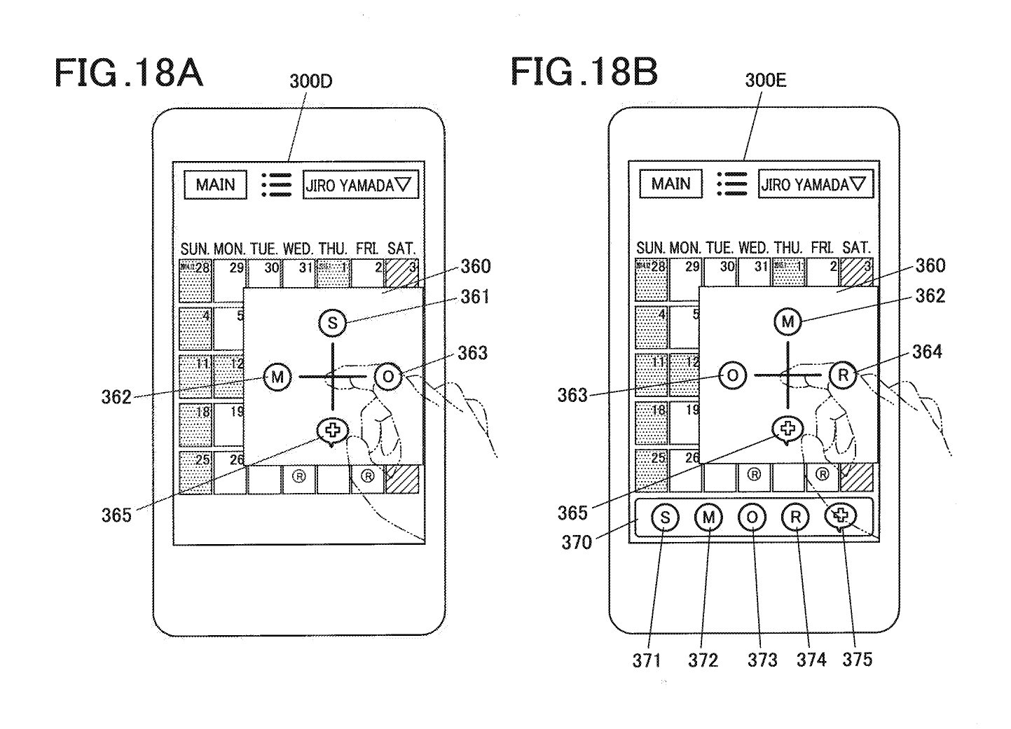

In the embodiment, as shown in FIG. 12B, when the stamp selection screen 360 is displayed, there are set a stamp button (not displayed) corresponding to the stamp which is first in the choosing order at the position in the center of the screen, a stamp button 362 corresponding to the stamp which is second in the choosing order at the position in the upper side of the screen, a stamp button 363 corresponding to the stamp which is third in the choosing order at the position in the left side of the screen, a stamp button 364 corresponding to the stamp which is fourth in the choosing order at the position in the right side of the screen and a display button 365 at the position in the lower side of the screen. However, the setting positions of the stamp buttons corresponding to the chosen stamps and the display button are not limited to this. For example, as shown in a business communication screen 300D of FIG. 18A, there may be set a stamp button (stamp button of stocktaking) corresponding to the stamp which is first in the choosing order at the position in the upper side of the screen of the stamp selection screen 360, a stamp button (stamp button of message) corresponding to the stamp which is second in the choosing order at the position in the left side of the screen, a stamp button (stamp button of order) corresponding to the stamp which is third in the choosing order at the position in the right side of the screen and an display button 365 at the position in the lower side of the screen. In a case of confirmation sheet mode, as described above, since only the stamp of D mark is used, the stamp button corresponding to the stamp of D mark is set at the position in the upper side of the screen. In a case of shift mode, since three types of stamps of ∘ mark, x mark and Δ mark are used, there is set a stamp button (for example, stamp button of ∘ mark) corresponding to the stamp which is first in the choosing order at the position in the upper side of the screen, a stamp button (for example, stamp button of x mark) corresponding to the stamp which is second in the choosing order at the position in the left side of the screen, and a stamp button (for example, stamp button of Δ mark) corresponding to the stamp which is third in the choosing order at the position in the right side of the screen.

In the embodiment, when touch input is performed to the schedule frame of Thursday, Jan. 15, 2015 of the calendar display region 330 as shown in FIG. 12A and the stamp selection screen 360 is displayed as shown in FIG. 12B, a selection candidate confirmation display region 370 for confirming the stamp buttons which were determined to be selection candidates may appear below the calendar display region 330 as shown in a business communication screen 300E of FIG. 18B. The display of selection candidate confirmation display region 370 disappears by finishing the touch input of schedule frame, that is, by the user releasing the finger from the schedule frame to which the touch operation was performed. In the selection candidate confirmation display region 370, stamp buttons which were displayed (set) on the stamp selection screen 360 are displayed. Specifically, as shown in FIG. 18B, in a case where there are displayed (set) a stamp button (not displayed) corresponding to the stamp of stocktaking which is first in the choosing order, a stamp button 362 corresponding to the stamp of message which is second in the choosing order, a stamp button 363 corresponding to the stamp of order which is third in the choosing order, a stamp button 364 corresponding to the stamp of reservation which is fourth in the choosing order and a display button 365 on the stamp selection screen 360, there are displayed a stamp button 371 corresponding to the stamp of stocktaking, a stamp button 372 corresponding to the stamp of message, a stamp button 373 corresponding to the stamp of order, a stamp button 374 corresponding to the stamp of reservation and a display button 375 in the order from left in accordance with the above choosing order on the selection candidate confirmation display region 370. Though not shown in the drawings, in the confirmation sheet mode, there is only displayed a stamp button corresponding to the stamp of D mark on the selection candidate confirmation display region. In the shift mode, stamp buttons (three types of stamp buttons of ∘ mark, x mark and Δ mark) are displayed in the order from left in accordance with the choosing order on the selection candidate confirmation display region.

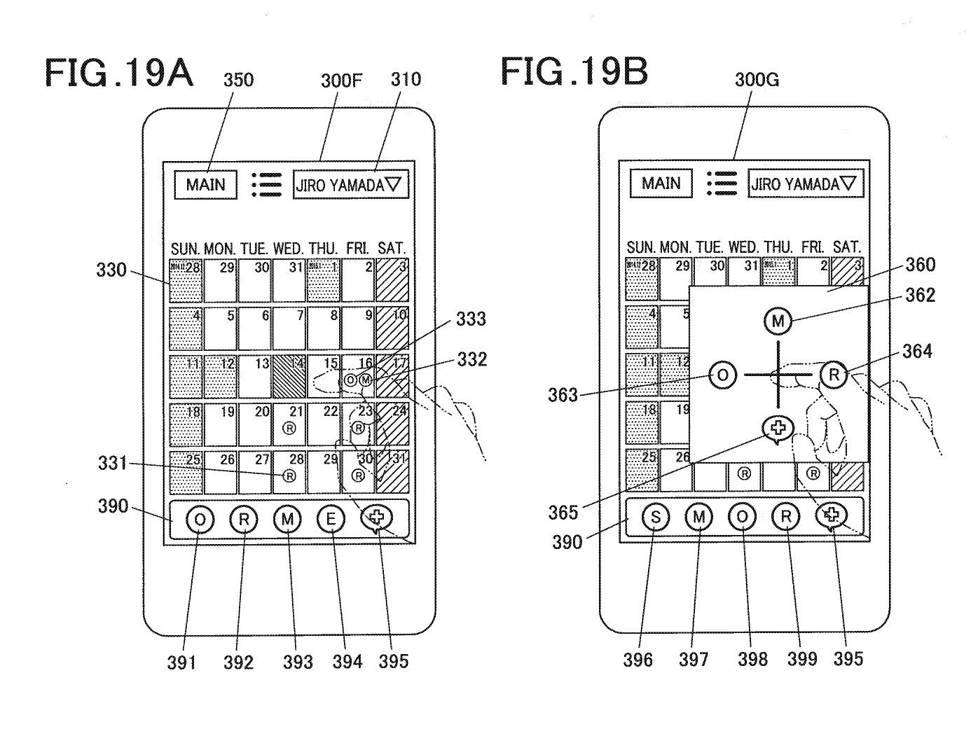

In the embodiment, the terminal apparatus 20 displays any screen among the business communication screen, confirmation sheet screen and shift screen, corresponding to steps S22 and S26 of stamp attachment display control processing by the server 10. When these screens are displayed, there may be further provided a stamp button selection region on the screen. The stamp button selection region is a display region having stamp buttons for selection at the time of stamp registration. Specifically, as shown in FIG. 19A, the stamp button selection region 390 of a business communication screen 300F has an order stamp button 391, a reservation stamp button 392, an event stamp button 393, a message stamp button 394 and a display button 395, for example. The stamp buttons 391, 392, 393 and 394 set in the stamp button selection region 390 are selected as stamp buttons corresponding to the input history 37 of login user (Jiro Yamada) which is stored in the account data table 30 when the business communication screen 300F is displayed. Though not shown in the drawings, the stamp button selection region of the confirmation sheet screen has only the stamp button corresponding to the stamp of D mark. The stamp button selection region of the shift screen has three types of stamp buttons of the ∘ mark, x mark and Δ mark. The three types of stamp buttons of the ∘ mark, x mark and Δ mark are displayed in the order corresponding to the input history of the login user.

As shown in FIG. 19A, in a state in which a stamp button selection region 390 is displayed on the business communication screen 300F, when touch input is performed to the schedule frame of Thursday, Jan. 15, 2015 of the calendar display region 330 and the stamp selection screen 360 is displayed as shown in a business communication screen 300G of FIG. 19B, the stamp buttons 391, 392, 393 and 394 displayed on the stamp button selection region 390 may be replaced with the respective stamp buttons which were set in the stamp selection screen 360 as the selection candidates. Specifically, in a case where, as stamps of selection candidates, the stamp of stocktaking is chosen as first in the choosing order, the stamp of message is chosen as second in the choosing order, the stamp of order is chosen as third in the choosing order and the stamp of reservation is chosen as the fourth in the choosing order, the stamp buttons 391, 392, 393 and 394 which have been displayed in the stamp button selection region 390 are respectively replaced with the stamp button 376 corresponding to the stamp of stocktaking, the stamp button 377 corresponding to the stamp of message, the stamp button 378 corresponding to the stamp of order and the stamp button 379 corresponding to the stamp of reservation in the order from left end of the stamp button selection region 390 in accordance with the choosing order. Even after the touch input to the schedule frame of Thursday, Jan. 15, 2015, the stamp buttons 376, 377, 378 and 379 after replacement are displayed on the stamp button selection region 390. Though not shown in the drawings, in the confirmation sheet mode, regardless of the touch input to the schedule frame of calendar display region 330, the stamp button corresponding to the stamp of D mark is displayed on the stamp button selection region. In a case of shift mode, at the beginning of display of shift screen, the stamp buttons (three types of stamp buttons of ∘ mark, x mark and Δ mark) are displayed in the order corresponding to the input history of login user on the selection candidate confirmation display region. After the touch input of the schedule frame, in accordance with the choosing order of stamp buttons which were chosen as selection candidates and set on the stamp selection screen, the stamp buttons (three types of stamp buttons of ∘ mark, x mark and Δ mark) are displayed in the order from left.

In the embodiment, the input condition of stamp for the task of order is that the mode is the business communication mode as shown in the stamp data table 60 of FIG. 7. However, the present invention is not limited to this. For example, information indicating the stock quantity of a product which is a target of the task of order may be periodically recorded and the input condition of the stamp of the order task may be that the mode is the business communication mode and the stock quantity of the product is less than a predetermined number.

In the embodiment, in step S42 of the business communication processing, the stamp input count 36 of the login user is referred to and the four stamps having largest stamp input counts are chosen from the stamps extracted in step S36. However, the present invention is not limited to this. For example, the stamp input count of the stamp input count 36 may be recorded for each day of week when the input was performed in the past, and there may be chosen four stamps having largest stamp input counts at the timing (day of week) when the schedule frame was selected. The stamp input count of the stamp input count 36 may be recorded for each day of week of the schedule frame for which stamp input was performed, and there may be chosen four stamps having largest stamp input counts at the timing (day of week) indicated by the date information of the selected schedule frame.

In the embodiment, as shown in FIG. 12B, in a state in which the stamp selection screen 360 is displayed, any stamp button among the buttons which are first to fourth in the choosing order or the display button is selected by releasing the touch operation or performing the flick operation. However, the present invention is not limited to this. For example, the dialogue selection screen may be displayed instead of the stamp selection screen 360 so that, on the dialog selection screen, the stamps which are first to fourth in the choosing order are displayed by the stamp buttons in a toggle button form and similarly the display button in a toggle button form is displayed. A stamp button desired by the user may be selected and input from the stamp buttons or the display button. A list of the stamps which are first to fourth in the choosing order may be displayed in a pull-down manner instead of the stamp selection screen 360. The stamp desired by the user may be selected and input from the displayed list.

The combination of choosing methods of stamps which are selection candidates and the choosing procedures in the embodiment are examples, and the present invention is not limited to the examples. The combination of choosing methods of stamps which are selection candidates and the choosing procedures can be appropriately and arbitrarily changed.

The embodiment has been described by taking an example of applying the shop data management system 1 to restaurant business (a restaurant). However, the present invention is not limited to this, and the shop data management system 1 can be applied to other business types. By the input using stamps in the shop data management system 1, it is possible to reduce the limitation of time by quick input and limitation of location by input with a portable terminal. Thus, by preparing stamps conforming to the business types, the present invention can be used in various business types.

In the embodiment, as shown in FIG. 20A, the calendar information is a schedule template in a monthly calendar type displaying a horizontal row for each week and a list of schedule frames in a staggered arrangement. However, the present invention is not limited to this. For example, as shown in FIG. 20B, the calendar information may be a schedule template provided with a plurality of schedule frames in a predetermined format, the schedule frames being correlated with time slot information for respective dates.

It goes without saying that changes can be appropriately made within a scope of the present invention for detailed configurations and detailed operations of the components in the shop data management system 1 in the embodiment.

Though the embodiment of the present invention has been described above, the scope of the present invention is not limited to the above embodiment, and includes the scope of inventions, which is described in the scope of claims, and the scope equivalent thereof.

What is claimed is:

1. An information processing apparatus, comprising:
a first display control section which performs control to display a schedule template that is provided with a plurality of schedule frames each of which is correlated with predetermined date information or time slot information;
a first selection section which selects a schedule frame desired by a user according to user's operation from among the plurality of schedule frames;
a choosing section which chooses a stamp mark as a selection candidate from among a plurality of stamp marks that are different from each other;
a second display control section which performs control to display the stamp mark as the selection candidate that is chosen by the choosing section; and
a second selection section which selects a predetermined stamp mark according to user's operation from among the stamp mark as the selection candidate that is displayed by the second display control section, wherein
the first display control section performs control to display the stamp mark which is selected by the second selection section by placing the stamp mark on the schedule frame which is selected by the first selection section in the schedule template.

2. The information processing apparatus according to claim 1, wherein the choosing section chooses the stamp mark as the selection candidate from among the plurality of stamp marks based on a situation when the schedule frame is selected by the first selection section.

3. The information processing apparatus according to claim 2, wherein
a stamp mark usable timing is set in advance for each of the plurality of stamp marks, and
the choosing section chooses a stamp mark for which a stamp mark usable timing matches a timing when the schedule frame is selected by the first selection section.

4. The information processing apparatus according to claim 3, wherein the choosing section chooses a stamp mark for which a stamp mark usable timing matches a timing indicated by the date information or the time slot information of the schedule frame that is selected by the first selection section.

5. The information processing apparatus according to claim 2, further comprising a first storage section which stores an input count information indicating a number of input for each of the plurality of stamp marks, wherein
the choosing section chooses a predetermined number of stamp mark having a largest number of input based on the input count information.

6. The information processing apparatus according to claim 2, wherein
the plurality of stamp marks includes a specific stamp mark for which attribute information indicating a specific attribute of a user is set in advance, and
the choosing section chooses, with priority, a specific stamp mark which has attribute information matching attribute information of the user that selects the schedule frame by the first selection section.

7. The information processing apparatus according to claim 2, further comprising a second storage section which stores history information indicating a history of a stamp mark which is input in a predetermined number of last input, wherein
the choosing section chooses a stamp mark indicated by the history information.

8. The information processing apparatus according to claim 1, further comprising:
a third display control section which performs control to display a plurality of stamp marks separately from the stamp mark as the selection candidate; and
a third selection section which selects a predetermined stamp mark according to user's operation from among the plurality of stamp marks displayed by the third display control section, wherein
the first display control section performs control to display the stamp mark selected by the third selection section by placing the stamp mark on the schedule frame selected by the first selection section in the schedule template, and
when the stamp mark as the selection candidate is chosen by the choosing section, the third display control section performs control to display the stamp mark as the selection candidate by replacing the plurality of stamp marks with the stamp mark as the selection candidate.

9. An information processing method, comprising:
a first display control step of performing control to display a schedule template that is provided with a plurality of schedule frames each of which is correlated with predetermined date information or time slot information;
a first selection step of selecting a schedule frame desired by a user according to user's operation from among the plurality of schedule frames;
a choosing step of choosing a stamp mark as a selection candidate from among a plurality of stamp marks that are different from each other;
a second display control step of performing control to display the stamp mark as the selection candidate that is chosen by the choosing step; and
a second selection step of selecting a predetermined stamp mark according to user's operation from among the stamp mark as the selection candidate that is displayed by the second display control step, wherein
the first display control step includes performing control to display the stamp mark which is selected by the second selection step by placing the stamp mark on the schedule frame which is selected by the first selection step in the schedule template.

10. The information processing method according to claim 9, wherein the choosing step includes choosing the stamp mark as the selection candidate from among the plurality of stamp marks based on a situation when the schedule frame is selected by the first selection step.

11. The information processing method according to claim 10, wherein
a stamp mark usable timing is set in advance for each of the plurality of stamp marks, and
the choosing step includes choosing a stamp mark for which a stamp mark usable timing matches a timing when the schedule frame is selected by the first selection step.

12. The information processing method according to claim 11, wherein the choosing step includes choosing a stamp mark for which a stamp mark usable timing matches a timing indicated by the date information or the time slot information of the schedule frame that is selected by the first selection step.

13. The information processing method according to claim 10, wherein
the plurality of stamp marks includes a specific stamp mark for which attribute information indicating a specific attribute of a user is set in advance, and
the choosing step includes choosing, with priority, a specific stamp mark which has attribute information matching attribute information of the user that selects the schedule frame by the first selection step.

14. The information processing method according to claim 9, further comprising:
a third display control step of performing control to display a plurality of stamp marks separately from the stamp mark as the selection candidate; and
a third selection step of selecting a predetermined stamp mark according to user's operation from among the plurality of stamp marks displayed by the third display control step, wherein
the first display control step includes performing control to display the stamp mark selected by the third selection step by placing the stamp mark on the schedule frame selected by the first selection step in the schedule template, and
the third display control step includes performing control to display the stamp mark as the selection candidate by replacing the plurality of stamp marks with the stamp mark as the selection candidate when the stamp mark as the selection candidate is chosen by the choosing step.

15. A non-transitory computer readable storage medium which stores a program for causing a computer of an information processing apparatus to execute a procedure comprising:
a first display control process of performing control to display a schedule template that is provided with a plurality of schedule frames each of which is correlated with predetermined date information or time slot information;
a first selection process of selecting a schedule frame desired by a user according to user's operation from among the plurality of schedule frames;
a choosing process of choosing a stamp mark as a selection candidate from among a plurality of stamp marks that are different from each other;
a second display control process of performing control to display the stamp mark as the selection candidate that is chosen by the choosing process; and
a second selection process of selecting a predetermined stamp mark according to user's operation from among the stamp mark as the selection candidate that is displayed by the second display control process, wherein
the first display control process includes performing control to display the stamp mark which is selected by the second selection process by placing the stamp mark on the schedule frame which is selected by the first selection process in the schedule template.

16. The computer readable storage medium according to claim 15, wherein the choosing process includes choosing the stamp mark as the selection candidate from among the plurality of stamp marks based on a situation when the schedule frame is selected by the first selection process.

17. The computer readable storage medium according to claim 16, wherein
a stamp mark usable timing is set in advance for each of the plurality of stamp marks, and
the choosing process includes choosing a stamp mark for which a stamp mark usable timing matches a timing when the schedule frame is selected by the first selection process.

18. The computer readable storage medium according to claim 17, wherein the choosing process includes choosing a stamp mark for which a stamp mark usable timing matches a timing indicated by the date information or the time slot information of the schedule frame which is selected by the first selection process.

19. The computer readable storage medium according to claim 16, wherein
the plurality of stamp marks includes a specific stamp mark for which attribute information indicating a specific attribute of a user is set in advance, and
the choosing process includes choosing, with priority, a specific stamp mark which has attribute information matching attribute information of the user that selects the schedule frame by the first selection process.

20. The computer readable storage medium according to claim 15, further comprising:
a third display control process of performing control to display a plurality of stamp marks separately from the stamp mark as the selection candidate; and
a third selection process of selecting a predetermined stamp mark according to user's operation from among the plurality of stamp marks displayed by the third display control process, wherein
the first display control process includes performing control to display the stamp mark selected by the third selection process by placing the stamp mark on the schedule frame selected by the first selection process in the schedule template, and
the third display control process includes performing control to display the stamp mark as the selection candidate by replacing the plurality of stamp marks with the stamp mark as the selection candidate when the stamp mark as the selection candidate is chosen by the choosing process.
